(19) United States
(12) Patent Application Publication
(10) Pub. No.: US 2008/0225455 A1
(43) Pub. Date: Sep. 18, 2008

(54) OVERCURRENT DETECTION LATCH CIRCUIT

(75) Inventors: Nicholas Scott Hartley, Chesterfield, MI (US); Scott J. Lucy, Lake Orion, MI (US); Thomas Scott Schaffer, Shelby Township, MI (US); John R. Costello, Rochester Hills, MI (US); James Anthony Poirier, Sterling Heights, MI (US)

Correspondence Address: CARLSON, GASKEY & OLDS, P.C., 400 WEST MAPLE ROAD, SUITE 350, BIRMINGHAM, MI, 48009, US

(73) Assignee: CONTINENTAL AUTOMOTIVE SYSTEMS US, INC., Auburn Hills, MI (US)

(21) Appl. No.: 12/047,483

(22) Filed: Mar. 13, 2008

Related U.S. Application Data
(60) Provisional application No. 60/906,695, filed on Mar. 13, 2007.

(51) Int. Cl. H02H 9/02

(52) U.S. Cl. 361/93.2

(57) ABSTRACT

An overcurrent detection circuit assembly provides a diagnostic feedback signal indicative of an overcurrent or short condition is disclosed. The detection circuit receives a sense current that is proportional to a load current provided to an electrical device or load. The detection circuit provides the feedback signal to a microcontroller that can control the device and the power supply to protect the device against short circuit or other fault condition.

### CROSS REFERENCE TO RELATED APPLICATION

The application claims priority to U.S. Provisional Application No. 60/906,695 which was filed on Mar. 13, 2007.

### BACKGROUND OF THE INVENTION

This disclosure describes a device for detecting overcurrent conditions. More particularly, this disclosure describes a circuit for detecting intermittent overcurrent conditions.

Current systems rely on a microcontroller to catch and detect intermittent failures utilizing a diagnostic feedback signal. However, an overcurrent condition may occur and subside quicker than can be detected by the microcontroller. Further, some microcontrollers do not continually monitor the diagnostic signal and can miss intermittent fault conditions. A permanent fault condition will be caught eventually, however the intermittent conditions may continue for some time without detection.

Accordingly, it is desirable to design and develop a circuit capable of detecting intermittent conditions.

### SUMMARY OF THE INVENTION

An example overcurrent detection circuit assembly provides a diagnostic feedback signal indicative of an overcurrent or short condition is disclosed. The detection circuit receives a sense current that is proportional to a load current provided to an electrical device or load. The detection circuit provides the feedback signal to a microcontroller that can control the device and the power supply to protect the device against short circuit or other fault condition.

The circuit assembly includes a latch to maintain the diagnostic signal in a state indicative of fault conditions independent of the level of the sense current. Accordingly, intermittent increases in the sense current will cause the diagnostic signal to latch at a high state, even if the sense current returns to a level within desired threshold limits. The diagnostic signal is transmitted to a microcontroller that will then initiate a defined response to protect the device. The diagnostic signal is reset to a level indicative of normal desired operation by a command from the microcontroller. The reset causes the comparator to return to a state where the sense current is measured and compared to the desired threshold value. The reset process provides for the filtering of noise values that may cause a latching of the diagnostic signal but are not indicative of a fault.

These and other features of the present invention can be best understood from the following specification and drawings, the following of which is a brief description.

### BRIEF DESCRIPTION OF THE DRAWINGS

FIG. 1 is a block diagram of an example overcurrent detection device.

FIG. 2 is a schematic illustration of an example circuit for detecting intermittent fault conditions.

FIG. 3 is a plot of an example fault and detection by the example circuit.

### DETAILED DESCRIPTION OF THE PREFERRED EMBODIMENT

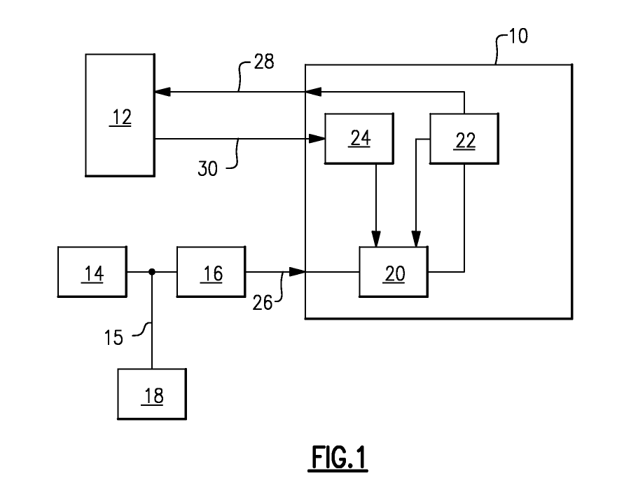

Referring to FIG. 1, an example overcurrent detection circuit assembly 10 provides an analog current sense diagnostic feedback signal 28 indicative of an overcurrent or short condition receives a sense current 26 that is proportional to a load current 15 provided to an electrical device or load 18. A power supply 14 provides the load current 15 that is proportionally replicated through a mirror circuit 16 that provides the desired portion of the load current 15 to the detection circuit assembly 10. The detection circuit 10 provides the feedback signal 28 to a microcontroller 12 that can control the device 18 and the power supply to protect the device 18 against short circuit or other fault condition.

The circuit assembly 10 includes a latch 22 to maintain the diagnostic signal 28 in a high state indicative of fault condition independent of the sense current. Accordingly, intermittent increases in the sense current will cause the diagnostic signal 28 to latch at the high state, even if the sense current 26 returns to a level within desired threshold limits. The diagnostic signal 28 is transmitted to a microcontroller 12 that will then initiate a defined response to protect the power supply 14 and electrical device 18.

The diagnostic signal 28 is reset to a level indicative of normal desired operation by a reset 24. The reset 24 is initiated by a command from the microcontroller 12. The reset 24 causes the comparator 20 to return to a state where the sense current 26 is measured and compared to the desired threshold value. The reset process provides for the filtering of noise values that may cause a latching of the diagnostic signal 28 in a high condition, but are not indicative of a fault. If however, upon reset of the comparator 20, another or several consecutive signal exceed the threshold value, the microcontroller 12 can initiate the defined actions, such as for example shutdown of the device 18, to protect the device 18.

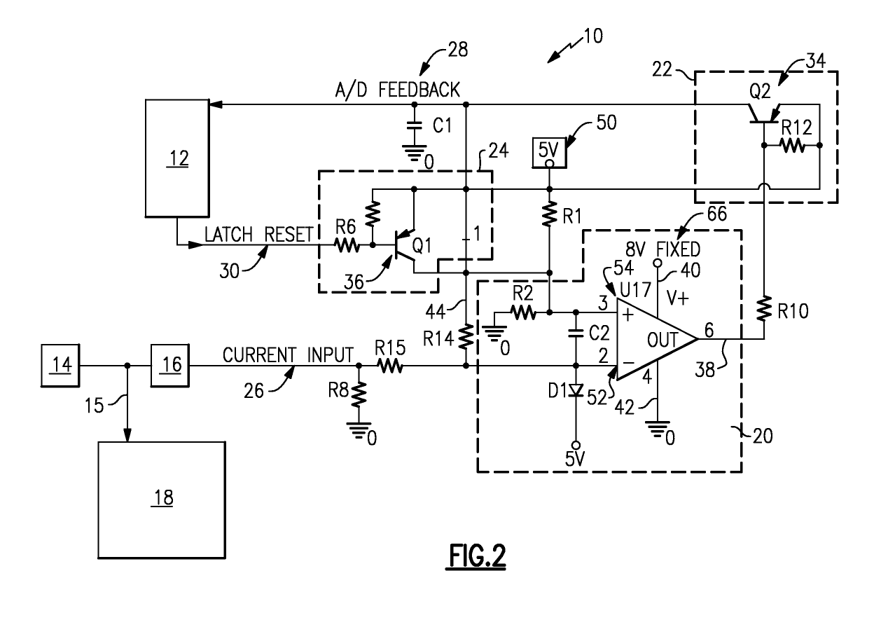

Referring to FIG. 2, the example circuit assembly 10 receives the sense current 26 which input to the comparator 20. The comparator 20 switches an output value 48 between a positive voltage 40 and a negative voltage 42 responsive to the level of the sense current 26. As the load current 15 rises, so will the sense current 26. A threshold value is determined by resistors R1 and R2. The value of the threshold is adjusted to meet application specific conditions by providing a proper combination of resistors R1 and R2. When the sense current 26 rises, so will the voltage across resistor R8. Once the voltage across resistor R8 exceeds the threshold value determined by resistors R1 and R2, the output 38 will switch from the voltage 40 to the negative voltage, in this example ground 42.

Once the output current 38 of the comparator 20 has been switched to ground, the latch 22 will move to a high state. In this example, the latch 22 includes a latch transistor 34. The negative voltage supply from the output 38 is supplied to the base of the latch transistor 34. This triggers the latch transistor 34 to pass voltage from the emitter to the collector. The emitter of the latch transistor 34 is coupled to the power supply 50. The collector of the latch transistor 34 is tied to the diagnostic signal 28 so that the microcontroller 12 will read a fault condition upon the next periodic check, and/or because the high signal is held until detection of the diagnostic signal 28.

The collector of the latch transistor 34 is also tied to the negative input 52 of the comparator 20. Because the negative input 52 is tied to the collector of the latch transistor 34, the output 38 of the comparator 20 remains latched, even if the sensed current 26 returns to within acceptable limits. Accordingly, an intermittent increase in current causes the example detection circuit 10 to output the diagnostic signal 28 at a level that indicates a fault condition, and maintain this level, until the fault is recognized by the microcontroller 12.

The input tied to the collector of the latch transistor 34 is tied back through resistor R14. The resistor R14 is set to provide a level of input just above the threshold value based on the power supply 50. Further, the voltage as the negative input 52 is determined based on the resistor divider R8, R15 and R14. Therefore, the comparator 20 is maintained switched to negative voltage supply 42.

Once the microcontroller 12 has received the signal 28 indicative of a fault condition, the detection circuit 10 can be reset. Resetting is accomplished by actuating a reset transistor 36. The microcontroller 12 pulls a latch reset signal 30 low to saturate the reset transistor 36 and pass the voltage on the emitter to the collector. The collector of the reset transistor 36 is tied to the positive input of the comparator 20. The voltage through the reset transistor 36 bypasses the resistor R1 to the positive input 54 providing a voltage higher than that to the negative input to switch the comparator 20 back to the open collector and the voltage from the negative input 52 is returned to that of the input sense current 26. The comparator 20 output 38 then initiates a return of the latch transistor 34 to the state were no voltage is passed from the emitter to the collector, and thereby to the diagnostic signal 28.

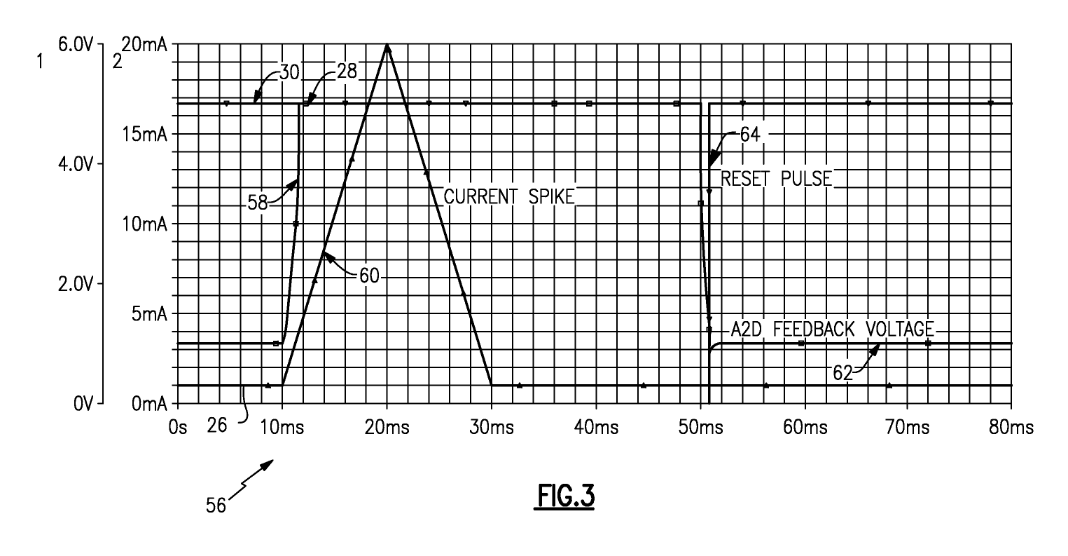

Referring to FIG. 3, a graph 56 illustrates an example latching of the diagnostic signal 28 in response to a current spike 60. The sense current 26 is shown beginning at an initial level within an acceptable normal operating range. The corresponding diagnostic signal 28 is within a normal range indicating acceptable levels. Upon encountering the spike 60, the diagnostic signal 28 will also rise due to the switching of the comparator 20 and latching of the latching transistor 34 to pass voltage from the emitter through to the collector, and thereby cause the quick rise indicated at 58 in the diagnostic feedback signal 28. The spike 60 ends quickly, but the diagnostic signal 28 remains at the increased voltage levels indicating the fault condition. The microcontroller 12 receives the diagnostic signal 28 as that signal is maintained for a period that enables the microcontroller 12 to recognize that the diagnostic signal 28 is now elevated. The reset signal 30 in this example is at a normally high state. Once the microcontroller 12 has recognized the fault the reset signal 64 is pulsed low as indicated at 64 to reset the comparator 20 and thereby the latch 22. The reset signal 30 is pulsed for a short duration and then returned to the normal high level. The diagnostic feedback signal 28 is also returned to a normal level as indicated at 62.

The example detection circuit 10 includes a fixed power supply 66. In order to maintain the positive input 54 and the negative inputs 52 to the comparator 20, the fixed power supply 66 is set to a fixed voltage determine to prevent a rise above a threshold voltage. In this example, the fixed power supply 66 is fixed at 8 volts, thereby preventing a voltage rise above 6 volts. Other values and voltages can be utilized based on application specific requirements.

In some applications, the current sense 26 is utilized to provide thermal status output. Such use can cause the current sense output to increase to a voltage greater than is desired for operation of the comparator 20. A diode D1 is included to clamp the negative input to the comparator 20 to a level just below the threshold value, in this example 6 volts. Further, some applications may require several different high side drivers within a product. The example detection circuit 10 can be duplicated so that multiple detection circuit 10 can share the same voltage references and therefore share a common latch reset signal 30. Additionally, a capacitor C2 has been added across the positive input 54 and the negative input 52 to increase noise rejection in the circuit 10.

The latching of the diagnostic signal in a condition indicative of a fault condition provides time for the microcontroller to detect and act on short current spikes indicative of intermittent shorting or overcurrent conditions. The microcontroller 12 can then act as desired to return the diagnostic signal back to a normal threshold value. If the current condition is a complete fault, upon reset, the diagnostic signal 28 would immediately be set back to the high state indicative of the fault.

Accordingly, the example detection circuit provides for the detection of intermittent overcurrent conditions that could be missed by the microcontroller.

Although a preferred embodiment of this invention has been disclosed, a worker of ordinary skill in this art would recognize that certain modifications would come within the scope of this invention. For that reason, the following claims should be studied to determine the true scope and content of this invention.

What is claimed is:

1. A circuit assembly for detecting an intermittent overcurrent condition comprising:
a feedback signal transmitted from the circuit assembly that is indicative of an overcurrent condition;
a comparator for detecting a sense current input, wherein the comparator outputs a signal causing the feedback signal to increase to a high level indicative of an overcurrent signal;
a latch maintaining the high level of the feedback signal regardless of a level of the sense current; and
a reset for resetting the latch to a level prior to the detection of the overcurrent condition in the sense current.

2. The assembly as recited in claim 1, including a microcontroller receiving the feedback signal and initiating a reset signal for resetting the latch.

3. The assembly as recited in claim 2, wherein the latch comprises a latch transistor including a base receiving an output from the comparator and an emitter communicating a voltage to a collector.

4. The assembly as recited in claim 3, wherein the reset comprises a reset transistor receiving a reset signal from the microcontroller that causes voltage to flow between an emitter and a collector.

5. The assembly as recited in claim 4, including a power supply communicating a threshold value to the comparator.

6. The assembly as recited in claim 5, including a first resistor disposed between the power supply and the comparator for defining the threshold value.

7. The assembly as recited in claim 6, wherein the reset transistor bypasses said first resistor to exceed the threshold value at an input to the comparator.

8. The assembly as recited in claim 1, wherein the comparator is tied to the collector of the latch transistor through a latch resistor.

9. A method of detecting an intermittent over current condition comprising the steps of:
comparing a sense current with a threshold value;
switching from a first state to a second state responsive to the sense current being greater than the threshold value;
switching a feedback signal to a high state indicative of an overcurrent condition;
latching the feedback signal in the high state; and
transmitting the feedback signal indicating an overcurrent condition to a device, wherein the device will perform a desired action responsive to the overcurrent condition.

10. The method as recited in claim 9, including the step of resetting the latched feedback signal to a normal state from the high state.

11. The method as recited in claim 10, wherein the device comprises a microcontroller, wherein the microcontroller controls power transmission to an electrical load in accordance with predefined protocols responsive to the feedback signal indicating the overcurrent condition.

12. The method as recited in claim 11, including the step of maintaining the feedback signal in the high state until reset.

13. The method as recited in claim 12, including the step of indicating an overcurrent condition responsive to a desired number of successive instances of the feedback signal being latched in the high state.

14. The method as recited in claim 9, including the step of adjusting a threshold value by selecting a combination of resistors between a power supply and an input to a comparator.
